(19) United States
(12) Patent Application Publication
(10) Pub. No.: US 2014/0164165 A1
(43) Pub. Date: Jun. 12, 2014

(54) REVERSE AUCTION SYSTEM, REVERSE AUCTION SUPPORT DEVICE AND PROGRAM

(71) Applicant: Katsuhisa Furuichi, Chiyoda-ku (JP)

(72) Inventor: Katsuhisa Furuichi, Chiyoda-ku (JP)

(73) Assignee: PURCHASING STRATEGY INSTITUTE CORPORATION, Chiyoda-ku, Tokyo (JP)

(21) Appl. No.: 14/236,174

(22) PCT Filed: Aug. 1, 2012
(86) PCT No.: PCT/JP2012/069555

§ 371 Date: Jan. 30, 2014

(30) Foreign Application Priority Data
Aug. 8, 2011 (JP) 2011-172723

(51) Int. Cl. G06Q 30/08; G06Q 30/06

(52) U.S. Cl. CPC G06Q 30/08; G06Q 30/0633
USPC 705/26.3

(57) ABSTRACT

A technological means that collects order applications from a larger number of buyers in a group-purchasing reverse auction. During an auction session T-k, a control unit 310 in a reverse auction support device 30 performs the following processes in parallel: displaying a latest bid price in response to a request from a buyer terminal 10-m; adding an order entry information item OD received from a buyer terminal 10-m, to an order management database ODB-k; displaying a latest total order count and latest bid price in response to a request from a supplier terminal 20-n; and appending a bid information item RD received from a supplier terminal 20-n, to a bid management database RDB-k. After the auction session T-k has ended, the control unit 310 selects a bid information item RD_{1ST} that has the highest bid rank, from among all the bid information items RD in the bid management database RDB-k.

### TECHNICAL FIELD

The present invention relates to technology for supporting electronic commerce.

### BACKGROUND ART

In general, there is a group purchasing reverse auction as one of transaction types of electronic commerce through a communication network. The group purchasing reverse auction is performed in such a manner that group purchasers of merchandise which has plenty of scope for a price cut by large orders are recruited among a plurality of buyers, and a person who sells merchandise in bulk to the buyer who becomes the group purchaser is determined by bidding-down performed by a plurality of suppliers. The group purchasing reverse auction proceeds in the following manner. An operator of the group purchasing reverse auction posts, on an auction site, an advertisement describing the specification and the like of an item to be auctioned. When wishing to purchase the target item posted on the auction site, a buyer who visits the auction site applies for group purchase by entering identification information of the item or the number of orders. After a predetermined recruitment period has elapsed, the operator notifies the plurality of suppliers of the total number of orders which each buyer has applied for during the period, and waits for the bid of a desired successful bid unit price from each of the suppliers. Then, the operator determines the supplier whose desired successful bid unit price is lowest as a successful bidder, and mediates a contract for the sale and purchase of the corresponding supplier with each buyer who is the group purchaser. As literature that discloses technology related to the group purchasing reverse auction, there is PTL 1.

### CITATION LIST

### Patent Literature

PTL 1: Japanese Unexamined Patent Application Publication No. 2005-301782

### SUMMARY OF INVENTION

### Technical Problem

However, among persons who participate in the group purchasing reverse auction as the buyers, there is someone who wants to have the item auctioned but will not purchase the item while paying a higher amount than an amount convenient for themselves. However, conventionally, in the group purchasing reverse auction, a period in which group purchases of the item to be auctioned are recruited and a period in which bidders for the item are recruited are completely separate. For this reason, there is a problem that the buyer must determine whether to apply for the purchase without knowing how much the price of the item to be auctioned would be competitively lowered.

The present invention has been made in view of such a problem, and aims to provide technical means that can collect order applications from a much greater number of buyers in the group purchasing reverse auction.

### Solution to Problem

In order to solve the above described problem, the present invention provides a reverse auction support system including: a buyer terminal used by each buyer of a target item that is a target of a reverse auction; a supplier terminal used by each supplier of the target item; and a reverse auction support device, in which the reverse auction support device includes a communication interface that communicates with the supplier terminal through a communication network while communicating with the buyer terminal through the communication network, a first database that associates a buyer identifier of each buyer with order entry information including the number of orders of the target item designated as an order condition by each buyer for storing the associated information, a second database that associates a supplier identifier of each supplier with bid information including a desired successful bid unit price for the target item designated as an order acceptance condition by each supplier for storing the associated information, and control means that executes, for a predetermined auction period for the target item, first processing for receiving a message requesting browsing of the most recent bid value of the target item from the buyer terminal through the communication interface, determining a minimum amount of the desired successful bid unit price indicated by the bid information in the second database as the most recent bid value at the time of reception of the message, and returning the bid value to the buyer terminal through the communication interface; second processing for receiving the order entry information from the buyer terminal through the communication interface, and updating stored contents of the first database by adding a pair of the buyer identifier of the buyer of a transmission source of the received order entry information and the order entry information to the first database; third processing for receiving a message requesting browsing of the total number of the most recent orders and the most recent bid value from the supplier terminal through the communication interface, determining the minimum amount of the desired successful bid unit price indicated by each piece of the bid information in the second database as the most recent bid value at the time of reception of the message while determining a sum of the number of orders indicated by each piece of order entry information in the first database as the total number of the most recent orders at the time of reception of the message, and returning the total number of the orders and the bid value to the supplier terminal through the communication interface; fourth processing for receiving the bid information from the supplier terminal through the communication interface, and updating stored contents of the second database by adding a pair of the supplier identifier of the supplier of a transmission source of the received bid information and the bid information to the second database; and after the auction period is completed, fifth processing for selecting the bid information whose bid is the first in order from each piece of the bid information in the second database at the time of completion of the auction period, and outputting a set of the selected bid information and all of the order entry information in the first database as an auction result of the reverse auction for the target item.

According to the present invention, a control unit of the reverse auction support device receives, for the auction period of the target item of the reverse auction, the bid information from the supplier terminal, and adds the bid information to the second database. Next, when receiving a message from the buyer terminal, the control unit requires the most recent bid value from each piece of bid information in the second database at the time of reception of the message, and returns the required bid value to the buyer terminal. In addition, when receiving the order entry information from the buyer terminal for the auction period of the target item of the reverse auction, the control unit adds the received order entry information to the first database. Next, when receiving a message from the supplier terminal, the control unit requires the most recent bid value from each piece of bid information in the second database while requiring the total number of the most recent orders from each order entry information in the first database at the time of reception of the message, and returns the required order condition and bid value to the supplier terminal. Thus, according to the present invention, the buyer may determine that a unit price of the target item of the reverse auction is subjected to bidding-down to the extent of his or her own planned amount for purchase, and then submit an application which is jointly ordered. Therefore, according to the present invention, the number of applications for orders from buyers who want to have the target item auctioned but will not purchase the target item while paying a higher amount than an amount convenient for themselves are driven up. In addition, according to the present invention, there can be such expected effects that an increase in the number of buyers drives up a bid at a lower desired successful bid unit price from the supplier, and the bid at the lower desired successful bid unit price drives up orders from a greater number of buyers. Therefore, according to the present invention, it is possible to make a scale merit due to group orders larger.

### BRIEF DESCRIPTION OF DRAWINGS

FIG. 1 is a block diagram showing a configuration example of a reverse auction support system according to a first embodiment of the present invention.

FIG. 2 is a diagram showing structures of various databases stored in a nonvolatile storage unit of a reverse auction support device of the same system.

FIG. 3 is a diagram showing an example of a communication sequence in the same system.

FIG. 4 is a diagram showing a display example of an item list screen displayed in a buyer terminal and a supplier terminal of the same system.

FIG. 5 is a diagram showing a display example of an order entry guidance screen displayed by a buyer terminal of the same system.

FIG. 6 is a diagram showing a database update process performed by a reverse auction support device of the same system.

FIG. 7 is a diagram showing a display example of a bid guidance screen displayed by a supplier terminal of the same system.

FIG. 8 is a diagram showing a database update process performed by a reverse auction support device of the same system.

### DESCRIPTION OF EMBODIMENTS

### First Embodiment

Hereinafter, a first embodiment of the present invention will be described with reference to the accompanying drawings.

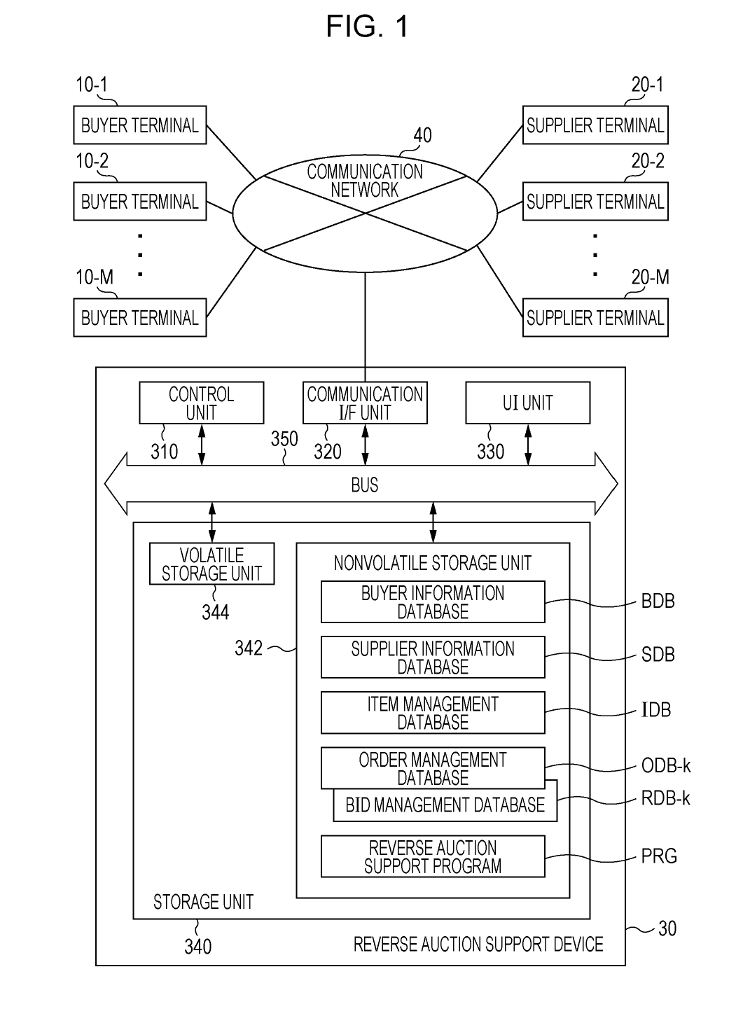

FIG. 1 is a diagram showing a configuration example of a reverse auction support system including a reverse auction support device 30 according to the first embodiment of the present invention. As shown in FIG. 1, the system includes buyer terminals 10-m (m=1 to M: M is the number of registrations of buyer terminals in the present system), supplier terminals 20-n (n=1 to N: N is the number of registrations of supplier terminals in the present system), and the reverse auction support device 30. As shown in FIG. 1, the buyer terminals 10-m, the supplier terminals 20-n, and the reverse auction support device 30 are connected to a communication network 40. The buyer terminal 10-m is a terminal device (for example, personal computer) of a buyer. The buyer means the person that is a purchaser of an item P-k (k=1, 2 . . . ) that is a target of a group purchasing reverse auction among participants in the group purchasing reverse auction. In the buyer terminal 10-m, a browser is implemented. The browser means an application program that transmits and receives data through a procedure based on hypertext transfer protocol (HTTP). In addition, in the buyer terminal 10-m, a buyer identifier ID_{B}-m that is an identifier for identifying each buyer is stored. The buyer identifier ID_{B}-m is issued to each buyer from a provider (hereinafter, simply referred to as operator) that is an operating body that operates the system at the time of registration of participation as a buyer in the reverse auction support system. In the buyer terminal 10-m, when data is transmitted to the reverse auction support device 30, the buyer identifier ID_{B}-M stored in the buyer terminal 10-m is included in transmission data. The supplier terminal 20-n is a terminal device (for example, personal computer) of a supplier that is a seller of each item P-k. Also in the supplier terminal 20-n, a browser is implemented. In the supplier terminal 20-n, a supplier identifier IDₛ-m that is an identifier for identifying each supplier is stored. The supplier identifier IDₛ-m is issued, to each supplier, from the operator at the time of registration of participation as the supplier in the reverse auction support system. In the supplier terminal 20-n, when data is transmitted to the reverse auction support device 30, the supplier identifier IDₛ-m stored in the supplier terminal 20-n is included in transmission data.

The reverse auction support device 30 is a server device that runs under management of the operator. The reverse auction support device 30 includes a control unit 310, a communication interface (hereinafter, referred to as “I/F”) unit 320, a user interface (hereinafter, referred to as “U/I”) unit 330, a storage unit 340, and a bus 350 for mediating data exchange among these components. The control unit 310 is for example, a central processing unit (CPU). The control unit 310 executes various programs stored in the storage unit 340, and functions as a control center of the reverse auction support device 30. The communication I/F unit 320 is, for example, a network interface card (NIC), and is connected to the communication network 40 via a relay device (not shown) such as a router. The communication I/F unit 320 receives a communication message (for example, communication message transmitted according to HTTP) or the like which is transmitted to the reverse auction support device 30 through the communication network 40 to pass the received message to the control unit 310, and sends, to the communication network 40, a communication message or the like passed from the control unit 310. The U/I unit 330 includes a display unit such as a liquid crystal display or the like and an operation unit such as a keyboard or the like (both not shown). The U/I unit 330 is intended to provide, to the operator, various user interfaces for performing operation management and maintenance of the reverse auction support device 30.

The storage unit 340 includes a volatile storage unit 344 and a nonvolatile storage unit 342. The volatile storage unit 344 is, for example, a random access memory (RAM). The volatile storage unit 344 is used as a work area when executing various programs. The nonvolatile storage unit 342 is, for example, a hard disk. In the nonvolatile storage unit 342, a buyer information database BDB, a supplier information database SDB, an item management database IDB, an order management database ODB-k corresponding to each item P-k, a bid management database RDB-k, and a reverse auction support program PRG are stored.

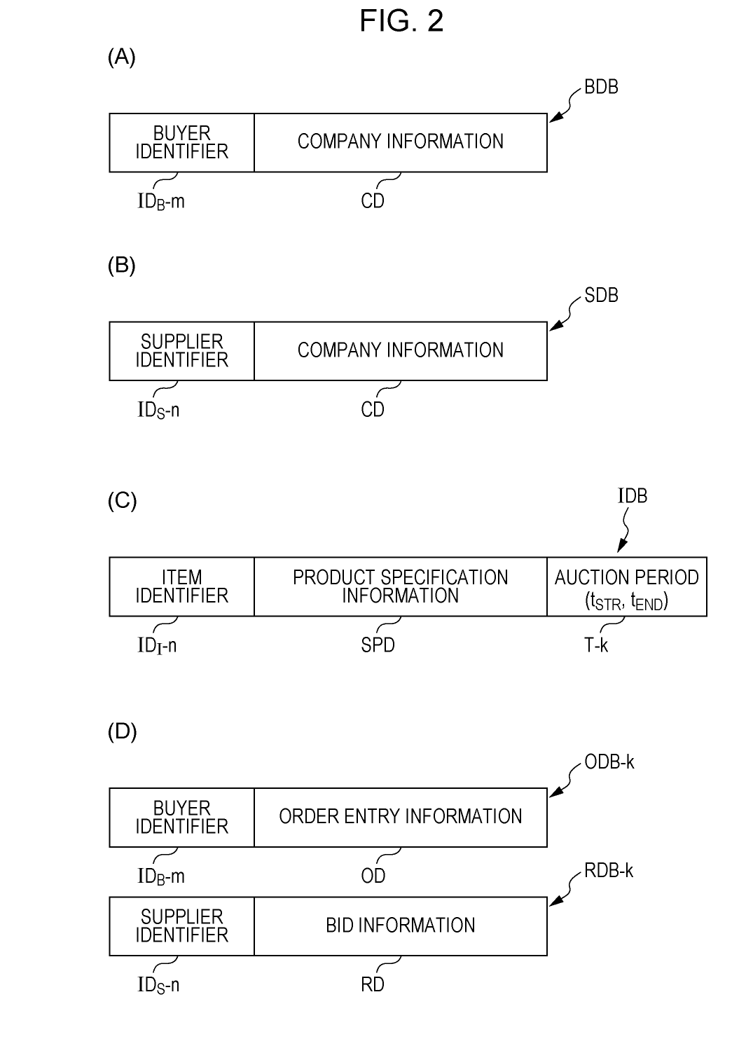

As shown in FIG. 2(A), the buyer information database BDB is an aggregate of records including the buyer identifier ID_{B}-m of the buyer and company information CD of the corresponding buyer. The company information CD includes information such as a company name, a type of business, a location, a capital, a name of an operator on duty, contact information, and the like. Whenever receiving an application for registration from a person who wants to register in the system as the buyer, the operator performs an operation of adding a new record including a buyer identifier ID_{B}-m unique to the person and company information CD declared by the person to the buyer information database BDB.

As shown in FIG. 2(B), the supplier information database SDB is an aggregate of records including the supplier identifier IDₛ-n of the supplier and a company information CD of the corresponding supplier. Also company information stored in the supplier information database SDB includes information such as a company name, a type of business, a location, a capital, a name of an operator on duty, contact information, and the like. Whenever receiving an application for registration from a person who wants to register in the system as the supplier, the operator performs an operation of adding a new record including a supplier identifier IDₛ-n unique to the person and a company information CD declared by the person to the supplier information database SDB.

As shown in FIG. 2(C), the item management database IDB is an aggregate of records including an item identifier ID_{I}-k of the item P-k, specification information SPD of the item P-k, and information indicating an auction period T-k which is determined for the item P-k. The specification information SPD includes information such as a product name, a grade, a unit price before discount, contour image data, and the like. The auction period T-k is defined by a start time t_{sTR} and an end time t_{END} of a group purchasing reverse auction for the item P-k. Whenever determining one kind of products as a target item P-k of the group purchasing reverse auction, the operator performs an operation of determining a item identifier ID_{I}-k unique to the item P-k, the specification information SPD, and the auction period T-k (start time t_{STR} and end time t_{END}) and adding a new record including these to the item management database IDB.

As shown in FIG. 2(D), the order management database ODB-k corresponding to a single item P-k is an aggregate of records including the buyer identifier ID_{B}-m of a buyer who applies for an order of the item P-k and order entry information OD indicating the number of orders designated as an order condition by the buyer. In addition, the bid management database RDB-k corresponding to the single item P-k is an aggregate of records including the supplier identifier ID_{E}-n of a supplier who applies for a bid for the item P-k and bid information RD indicating a desired successful bid unit price and a providable quantity designated as the order acceptance condition by the supplier. Here, in the first embodiment, whenever determining a single product as the target item P-k of the group purchasing reverse auction, the operator performs an operation of storing the order management database ODB-k and the RDB-k corresponding to the item P-k in the nonvolatile storage unit 342. Next, for the determined auction period T-k for the item P-k, the control unit 310 performs a process for adding a record including the bid information RD to the bid management database RDB-k corresponding to the item P-k by receiving the bid information RD from the supplier terminal 20-n while adding a record including the order entry information OD to the order management database ODB-k corresponding to the item P-k by receiving the order entry information OD from the buyer terminal 10-m. Detailed description thereof will be made later.

In FIG. 1, the reverse auction support program PRG in the nonvolatile storage unit 342 has the following five functions.

a1. Order Support Function

This is a function which receives a message MS₁₂₀ requesting browsing of the most recent bid value of the item P-k from the buyer terminal 10-m through the communication I/F unit 320 for the auction period T-k for the target item P-k of the group purchasing reverse auction, obtains the most recent bid value from the bid information RD within each record in the bid management database RDB-k at the time of reception of the message MS₁₂₀, and returns the obtained bid value to the buyer terminal 10-m through the communication I/F unit 320.

b1. Order Receiving Function

This is a function which receives the order entry information OD from the buyer terminal 10-m through the communication I/F unit 320 for the auction period T-k for the item P-k, and updates stored contents of the order management database ODB-k by adding a pair of a buyer identifier ID_{B}-m of a buyer of a transmission source of the received order entry information OD and the order entry information OD to the order management database ODB-k.

c1. Bid Support Function

This is a function which receives a message MS₂₂₀ requesting browsing of the total number of the most recent orders and the most recent bid value from the supplier terminal 20-n through the communication I/F unit 320 for the auction period T-k for the item P-k, obtains the most recent bid value from the bid information RD of each record in the bid management database RDB-k at the time of reception of the message MS₂₂₀ while obtaining the total number of the most recent orders from the order entry information OD within each record in the order management database ODB-k at the time of reception of the message MS₂₂₀, and returns the obtained total number of the orders and bid value to the supplier terminal 20-n through the communication I/F unit 320.

d1. Bid Acceptance Function

This is a function which receives the bid information RD from the supplier terminal 20-n through the communication I/F unit 320 for the auction period T-k for the item P-k, and updates stored contents of the bid management database RDB-k by adding a pair of a supplier identifier ID_{E}-n of a supplier of a transmission source of the received bid information RD and the bid information RD to the bid management database RDB-k.

e1. Auction Result Output Function

This is a function which selects, after the auction period T-k for the item P-k is completed, bid information RD_{1ST} whose bid is the first in order in the bid information RD within each record in the bid management database RDB-k auction result presentation message MS₄₁₀ including the bid information RD_{1ST} and the order entry information OD within all records of the order management database ODB-k, and outputs the message MS₄₁₀ to the communication I/F unit 320 to transmit the output message MS₄₁₀ from the communication I/F unit 320 to the communication network 40.

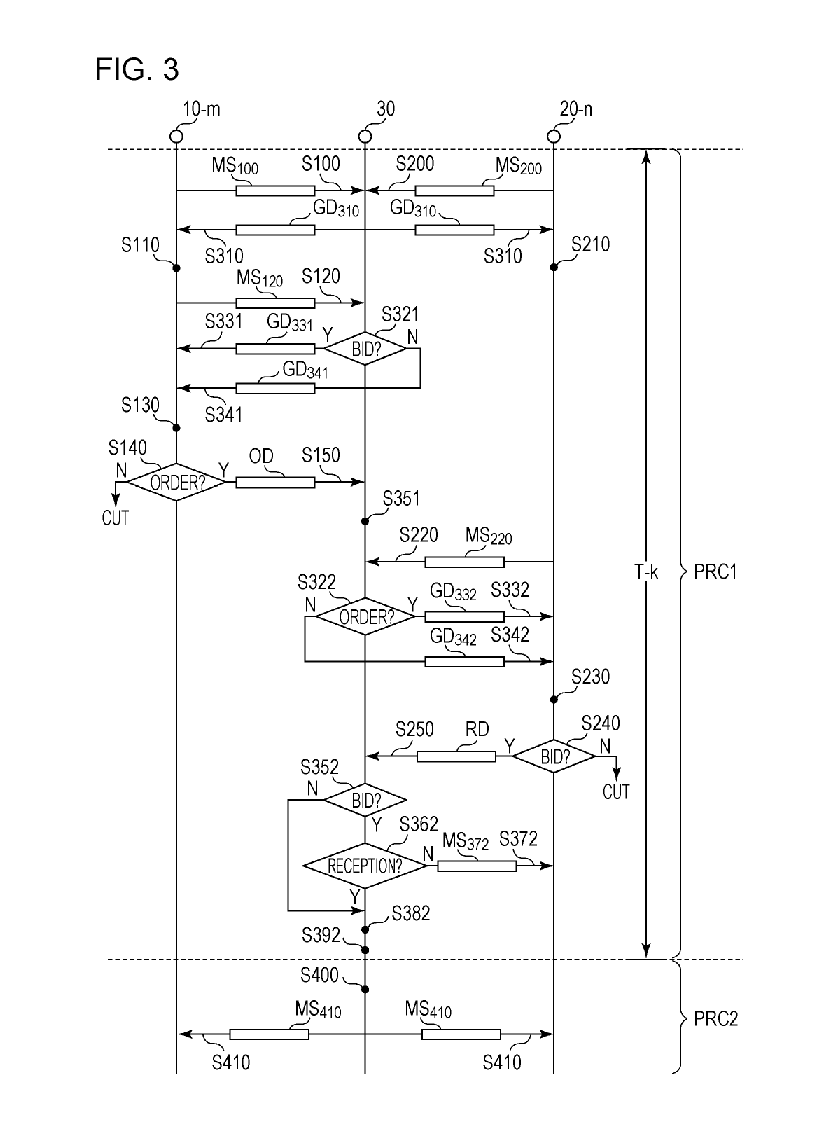

Next, operations of the first embodiment, for example, a competitive purchasing reverse auction for a target item P−1, will be described. FIG. 3 is a flowchart showing the operations of the first embodiment. As shown in FIG. 3, in the first embodiment, auction processing PRC1 with respect to the item P−1 is executed for an auction period T−1 for the item P−1, and auction result output processing PRC2 with respect to the item P−1 is executed after the auction period T−1 is completed. Here, steps S321 to S341 in FIG. 3 are processing executed by the action of the order support function. Step S351 in FIG. 3 is processing executed by the action of the order receiving function. Steps S322 to S342 in FIG. 3 are processing executed by the action of the bid support function. Steps S352 to S392 in FIG. 3 are processing executed by the action of the bid acceptance function. In addition, steps S400 and S410 are processing executed by the action of the auction result output function. Here, in FIG. 3, a single buyer terminal 10-m and a single supplier terminal 20-n are shown, but a plurality of buyer terminals 10-m and a plurality of supplier terminals 20-n are present. Thus, a case may occur in which accesses from the plurality of buyer terminals 10-m with respect to the reverse auction support device 30 compete or accesses from the plurality of supplier terminals 20-n with respect to the reverse auction support device 30 compete. In this case, for exclusive control by the reverse auction support device 30, well-known technologies are adopted. In addition, in the following descriptions, it is assumed that each supplier has a sufficient stock of the item P−1, and a providable quantity designated as an order acceptance condition by each supplier at each time point of the auction period T−1 is larger than a sum of the number of orders which may be designated as an order condition by each buyer for the auction period T−1.

In the auction processing PRC1 of FIG. 3, a buyer transmits a message MS₁₀₀ requesting browsing of a reverse auction site from his or her own buyer terminal 10-m when browsing the reverse auction site (S100). The message MS₁₀₀ is sent to the reverse auction support device 30. A supplier transmits a message MS₂₀₀ requesting browsing of the auction site from a supplier terminal 20-m when browsing the reverse auction site (S200). The message MS₂₀₀ is sent to the reverse auction support device 30. When receiving the message MS₁₀₀ or the message MS₂₀₀, the control unit 310 of the reverse auction support device 30 creates screen data GD₃₁₀ of an item list screen on which items (for example, items P−1 and P−2) corresponding to an auction period are listed among items P-k (k=1, 2, . . . ), and returns the screen data GD₃₁₀ (S310). More specifically, the control unit 310 extracts one or a plurality of records (in this case, records of items P−1 and P−2) in which a positional relation on a time axis between start and end times t_{STR} and t_{END} of the auction period T-k for the item P-k and a reception time t_{MS} of the message MS is t_{STR}<t_{MS}<t_{END}, from records of the target items P-k (k=1, 2, . . . ) in the item management database IDB (S310). Then, data in which the specification information SPD included in each of the extracted records is embedded in a model described by hyper text markup language (HTML) is used as the screen data GD₃₁₀.

The buyer terminal 10-m displays the item list screen on a display when receiving the screen data GD₃₁₀ (S110).

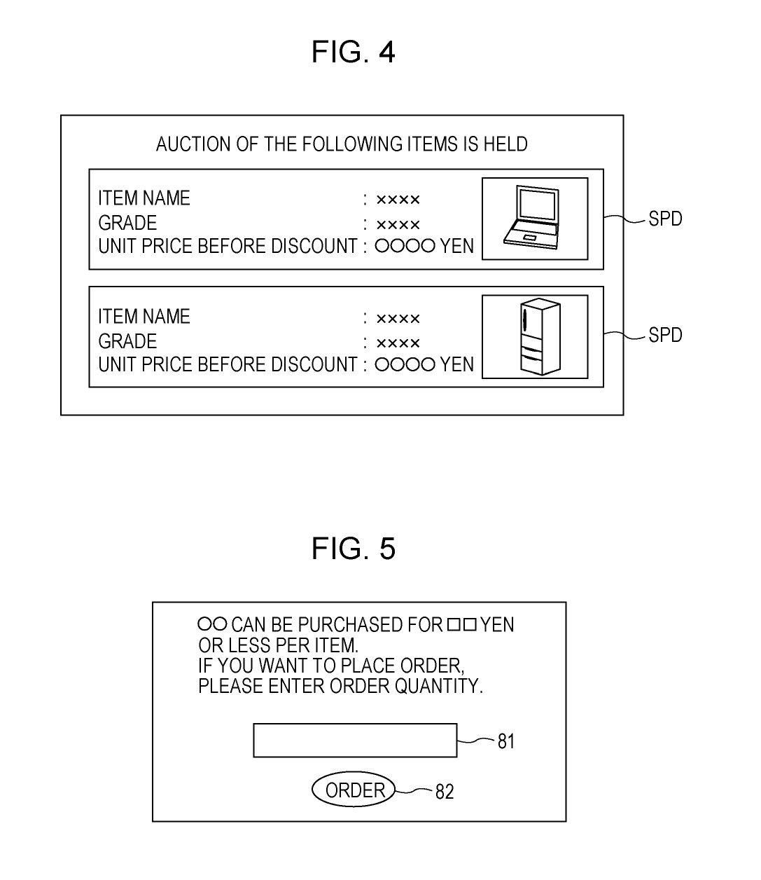

FIG. 4 is a diagram showing a display example of the item list screen. A character string “Auction for the following item is held” is written on an upper end of the item list screen. In addition, as shown in FIG. 4, on the item list screen, the specification information SPD of the item P−1 and the specification information SPD of the item P−2 are written so as to be vertically arranged below the character string written as “Auction for the following item is held”.

When there is an item (for example, item P−1) desired to be jointly ordered with others among the items P−1 and P-2 listed on the item list screen, the buyer performs an operation of selecting the item P−1 (S120). When performing the operation, the buyer terminal 10-m transmits a message MS₁₂₀ requesting browsing of the most recent bid value of the item P−1 to the reverse auction support device 30 (S120). When receiving the message MS₁₂₀, the control unit 310 of the reverse auction support device 30 determines whether there is bid information RD that has already been accepted with respect to the item P−1 (S321). More specifically, when not even one record is stored in a bid management database RDB−1, the control unit 310 determines that not even one bid information RD has been accepted, and when one or more records are stored in the bid management database RDB−1, the control unit 310 determines that one or more pieces of bid information RD have been accepted.

When determining that one or more pieces of bid information RD have been accepted in step S321 (S321: Yes), the control unit 310 creates screen data GD₃₃₁ of an order entry guidance screen including the most recent bid value at the time of reception of the message MS₁₂₀, and transmits the screen data GD₃₃₁ to the buyer terminal 10-m (S331). More specifically, the control unit 310 reads out the bid information RD within each record in the bid management database RDB−1 at the time of reception of the message MS₁₂₀ to the volatile storage unit 344 (S331). The control unit 310 determines a minimum amount of a desired successful bid unit price indicated by each piece of bid information RD in the volatile storage unit 344 as the most recent bid value of the item P−1. The control unit 310 uses data in which a product name of the item P−1 and the most recent bid value are embedded in a model described by HTML, as screen data GD₃₃₁.

When determining that even one bid information RD has not been accepted in step S321 (S321: No), the control unit 310 creates screen data GD₃₄₁ of an order entry screen including the product name of the item P−1 and a unit price before discount of the item P−1, and transmits the screen data GD₃₄₁ to the buyer terminal 10-m (S341). When receiving the screen data GD₃₃₁ or the screen data GD₃₄₁, the buyer terminal 10-m displays an order entry guidance screen on a display (S130). FIG. 5 is a diagram showing a display example of an order entry guidance screen. As shown in FIG. 5, on this order entry guidance screen, a character string “◯◯ (◯◯ being product name of item P−1) can be purchased for □□ yen (□□ being unit price before discount or the most recent bid value) or less per item; if you want to place an order, please enter order quantity” is written. On the order entry guidance screen shown in FIG. 5, an input space 81 is disposed below the character string “◯◯ (◯◯ being product name of item P−1) can be purchased for □□ yen (□□ being unit price before discount or the most recent bid value) or less per item. If you want to place an order, please enter order quantity”. In addition, on the order entry guidance screen shown in FIG. 5, a button 82 labeled as “order” is disposed below the input space 81. A buyer determines a bid value (□□ yen) on the order entry screen. Next, when ordering the item P−1, the buyer performs an operation of entering a desired order quantity in the input space 81 and selecting the button 82. In addition, when the bid value (□□ yen) of the item P−1 is higher than his or her own planned amount for purchase, the buyer may withhold an order of the item P−1 at this point. In this case, the buyer performs an operation of cutting the connection between the buyer terminal 10-m and the reverse auction support device 30. When the operation of selecting the button 82 of “order” is performed (S140: Yes), the buyer terminal 10-m creates order entry information OD including the number of orders input in the input space 81, and transmits the created order entry information OD to the reverse auction support device 30 (S150).

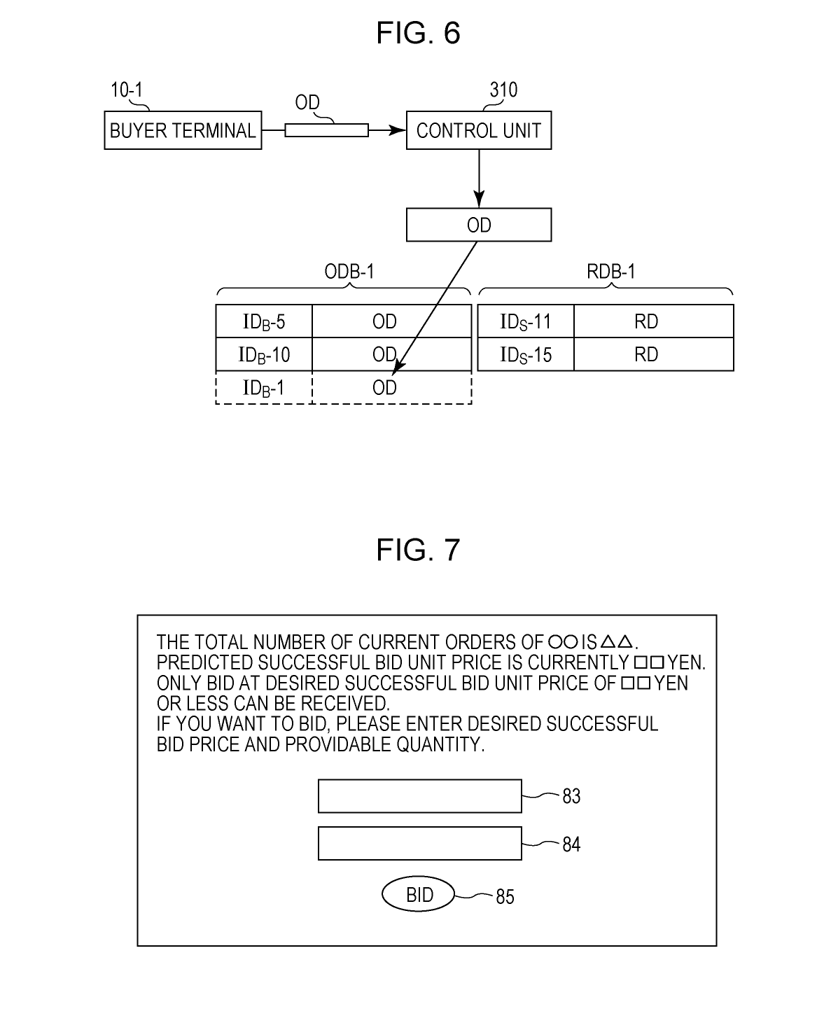

When receiving the order entry information OD from the buyer terminal 10-m, the control unit 310 of the reverse auction support device 30 creates a new record including a pair of a buyer identifier ID_{B}-m (in an example of FIG. 6, buyer identifier ID_{B}−1) of a buyer that is a transmission source of the order entry information OD and the order entry information OD as shown in FIG. 6, and adds the created record to the order management database ODB−1 (S351).

In FIG. 3, when receiving the screen data GD₃₁₀, the supplier terminal 20-n displays an item list screen on a display (S210). Displayed contents of the item list screen displayed on the display of the supplier terminal 20-n are the same as in a layout of the item list screen displayed on the display of the buyer terminal 10-m.

When there is an item (for example, assumed to be item P−1) desired to be sold to the buyer in a lump in the target items P−1 and P−2 listed in the item list screen, the supplier performs an operation of selecting the item P−1. When the operation is performed by the supplier, the supplier terminal 20-n transmits a message MS₂₂₀ requesting browsing of the total number of the most recent orders for the item P−1 and the most recent bid value for the item P−1 to the reverse auction support device 30 (S220). When receiving the message MS₂₂₀, the control unit 310 of the reverse auction support device 30 determines whether there is order entry information OD that has already been accepted with respect to the item P−1 (S322). More specifically, when even one record is not stored in the order management database ODB−1, the control unit 310 determines that even one order entry information OD has not been accepted, and when one or more records are stored in the order management database ODB−1, the control unit 310 determines that one or more pieces of order entry information OD have been accepted.

When determining that one or more pieces of order entry information OD have been accepted in step S322 (S322: Yes), the control unit 310 creates screen data GD₃₃₂ of a bid guidance screen including the total number of the most recent orders and the most recent bid value at the time of reception of the message MS₂₂₀, and transmits the created screen data GD₃₃₂ to the supplier terminal 20-n(5332). More specifically, the control unit 310 reads the order entry information OD within each record in the order management database ODB−1 at the time of reception of the message MS₂₂₀ out to the volatile storage unit 344. The control unit 310 adds up the number of orders indicated by each order entry information OD within the volatile storage unit 344, and uses the added-up number as the total number of the most recent orders of the item P−1. In addition, the control unit 310 reads the bid information RD of each record in the bid management database RDB−1 at the time of reception of the message MS₂₂₀ out to the volatile storage unit 344, and ranks each piece of bid information RD in the volatile storage unit 344 starting from bid information RD indicating the lowest desired successful bid unit price. Here, in a case in which there are a plurality of pieces of bid information RD indicating the desired successful bid unit price of an equal amount in the bid information RD within the volatile storage unit 344, the bid information having a larger providable quantity gains a higher ranking. The control unit 310 determines the desired successful bid unit price indicated by the bid information RD_{1ST} whose bid is the first in order as the most recent bid value. In addition, the control unit 310 uses the total number of the most recent orders of the item P−1 which is obtained in advance and data in which the desired successful bid unit price indicated by the bid information RD_{1ST} whose bid is the first in order is embedded in a model described by HTML as the screen data GD₃₃₂.

When determining that even one order entry information OD has not been accepted in step S322 (S322: No), the control unit 310 creates screen data GD₃₄₂ of a bid guidance screen including a minimum transaction quantity (for example, one) in the buying and selling of the item P−1 and a unit price before the discount of the item P−1, and transmits the created screen data GD₃₄₂ to the supplier terminal 20-n (S342). When receiving the screen data GD₃₃₂ or GD₃₄₂, the supplier terminal 20-n displays the bid guidance screen on a display (S230). FIG. 7 is a diagram showing a display example of a bid guidance screen. On the screen, a character string of “The number of current orders of ◯◯ (◯◯ being product name of item P−1) is ΔΔ (ΔΔ being minimum transaction quantity or total number of orders). Predicted successful bid unit price is currently □□ yen (□□ being unit price before discount or bid value). Only bid at desired successful bid unit price of □□ yen or less can be accepted. If you want to bid, please enter desired successful bid unit price and providable quantity” are written, and an input space 83 and an input space 84 are disposed below the character strings. On the bid guidance screen shown in FIG. 7, a button 85 labeled as “bid” is disposed below the input space 84. The supplier determines the number of orders (ΔΔ orders) and the bid value (□□ yen) of the bid guidance screen. Next, when placing a bid for the item P−1, the supplier performs an operation of selecting the button 85 by entering the providable quantity in the input space 84 while entering the desired successful bid unit price in the input space 83. In a case in which the supplier feels, when the desired successful bit unit price less than or equal to the most recent bid value is attached, that it is unprofitable, the supplier may withhold a bid in this instance. In this case, the supplier performs an operation of cutting the connection between the supplier terminal 20-n and the reverse auction support device 30. When an operation of selecting the button 85 of “order” is performed (step S240: Yes), the supplier terminal 20-n creates the bid information RD including an item identifier ID_{I}−1 of the item P−1, the desired successful bid unit price entered in the input space 83, and the providable quantity entered in the input space 84, and transmits the created bid information RD to the reverse auction support device 30 (S250).

When receiving the bid information RD from the supplier terminal 20-n, the control unit 310 of the reverse auction support device 30 determines whether there is the bid information RD that has already been accepted with respect to the item P−1 (S352). A specific procedure of the determination in step S352 is the same as in step S322.

When determining that one or more pieces of bid information RD are accepted in step S352 (step S352: Yes), the control unit 310 determines the bid information RD received from the supplier terminal 20-n as a determination target, and determines whether to accept a new bid by the bid information RD determined as the determination target (S362). In step S362, only when the bid information RD determined as the determination target indicates an order acceptance condition exceeding the bid information RD that has already been accepted, the control unit 310 determines to accept the new bid as a determination result. More specifically, the control unit 310 reads out the bid information RD within each record in the bid management database RDB−1 corresponding to the item P−1 to the volatile storage unit 344. Next, each piece of bid information RD within the volatile storage unit 344 is ranked in the same manner as in step S322, and the bid information RD₁ₛₜ whose bid is the first in order is selected from each piece of bid information RD. When the bid information RD satisfies one of the following two conditions based on a comparison between the bid information RD_{1ST} whose bid is the first in order and the bid information RD received from the supplier terminal 20-n, the control unit 310 determines to allow the new bid by the bid information RD received from the supplier terminal 20-n as the determination result.

a2. Desired successful bid unit price is lower than that of bid information RD_{1ST}
b2. Desired successful bid unit price is the same amount as that of bid information RD_{1ST}, and providable quantity is larger than that of bid information RD_{1ST}

When determining not to accept the new bid in step S362 (S362: No), the control unit 310 transmits a message MS₃₇₂ encouraging a re-bid whose order acceptance condition is changed to the supplier terminal 20-n (S372). When receiving the message MS₃₇₂, the supplier terminal 20-n displays character strings written as “You cannot bid in this order acceptance condition. Consider re-bid at lower desired successful bid unit price” on a display.

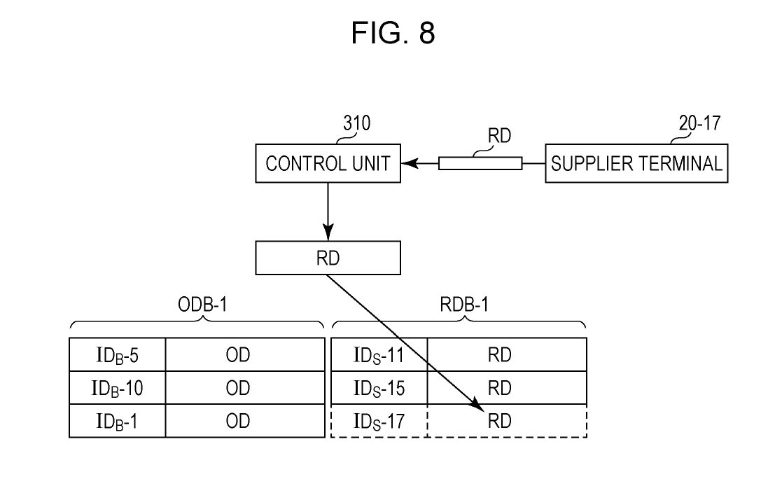

When determining to accept the new bid in step S362 (S362: Yes), the control unit 310 creates a new record including a pair of a supplier identifier IDₛ-n (in example of FIG. 8, supplier identifier IDₛ−17) of a supplier that is a transmission source of the bid information RD and the bid information RD as shown in FIG. 8, and adds the created new record to the bid management database RDB−1 (S382). In addition, when determining that not even one bid information RD has been accepted in step S352 (S352: No), the control unit 310 immediately proceeds to step S382 without determining whether to accept the new bid. The control unit 310 adds the record to the bid management database RDB−1, and then transmits a message indicating that the new bid has been made to the supplier terminal 20-n of a transmission source of the bid information RD whose bidding order has been the first so far (S392).

Here, in the first embodiment, the control unit 310 executes in parallel step S310 triggered by the reception of the message MS₁₀₀ from the buyer terminal 10-m or the reception of the message MS₂₀₀ from the supplier terminal 20-n, steps S321 to S341 triggered by the reception of the message MS₁₂₀ from the buyer terminal 10-m, step S351 triggered by the reception of the order entry information OD from the buyer terminal 10-m, steps S322 to S342 triggered by the reception of the message MS₂₂₀ from the supplier terminal 20-n, and steps S352 to S392 triggered by the reception of the bid information RD from the supplier terminal 20-n. These operations are executed from a start time t_{STR} of the auction period T−1 for the target item P−1 to an end time t_{END} thereof, and in the order management database ODB−1, the order entry information OD accepted by the control unit 310 within the period T−1 is stored in order. In addition, in the bid management database RDB−1, the bid information RD accepted by the control unit 310 within the period T−1 is stored in order.

In the auction result output processing PRC2 of FIG. 3, the control unit 310 selects the bid information RD_{1ST} whose bid is the first in order from each piece of bid information RD within each record in the bid management database RDB−1 at the end time t_{END} of the auction period T−1 for the item P−1 (S400). More specifically, the control unit 310 searches for the bid information RD (that is, bid information having the lowest desired successful bid unit price) that is finally added to the end of the bid management database RDB−1 among each piece of bid information RD of the bid management database RDB−1, and determines the searched bid information RD as the bid information RD_{1ST} whose bid is the first in order. Next, the control unit 310 reads out the bid information RD_{1ST} selected in step S400 and the order entry information OD within each record in the order management database ODB−1 to the volatile storage unit 344, creates an auction result notification message (e-mail message) MS₄₁₀ including the bid information RD_{1ST}, the order entry information OD, and directions representing a procedure of a conclusion of the contract for the sale and purchase, and outputs the created message MS₄₁₀ to the U/I unit 330 to transmit the output message MS₄₁₀ from the U/I unit 330 to the communication network 40 (S400). The message MS₄₁₀ is sent to the buyer terminal 10-m of each buyer that is a group orderer of the contract for the sale and purchase of the item P−1 and the supplier terminal 20-n of the supplier that is the successful bidder. Each buyer and each supplier conclude the contract for the sale and purchase of the item P−1 according to the directions of the message MS₄₁₀.

Here, the order entry information OD is transmitted from the buyer terminal 10-m to the reverse auction support device 30 for the auction period T−1 for the item P−1, but if the bid information RD is not sent at all from the supplier terminal 20-n to the reverse auction support device 30, in the auction result output processing PRC2, the bid information RD_{1ST} whose bid is the first in order cannot be determined. Thus, in this case, in the auction result output processing PRC2, the control unit 310 transmits a message indicating that the auction has failed to the buyer terminal 10-m that has transmitted the order entry information OD for the auction period T−1 for the item P−1. In addition, the bid information RD is transmitted from the supplier terminal 20-n to the reverse auction support device 30 for the auction period T−1 for the item P−1, but if the order entry information OD is not sent at all from the buyer terminal 10-m to the reverse auction support device 30, there is no the other party to provide the item P−1 having the order acceptance condition indicated by the bid information RD1ST even though the bid information RD1ST whose bid is the first in order is determined in the auction result output processing PRC22. Thus, in the auction result output processing PRC2 of this case, the control unit 310 transmits the message indicting that the auction has failed to the supplier terminal 20-n that has transmitted the bid information RD for the auction period T−1 for the item P−1.

As described above, in the first embodiment, the control unit 310 of the reverse auction support device 30 executes the following four processing for the auction period T-k for the target item P-k of the reverse auction. In a first processing, when receiving the message MS₁₂₀ from the buyer terminal 10-m, the control unit 310 obtains the most recent bid value from each piece of bid information RD in the bid management database RDB-k at the time of reception of the message MS₁₂₀, and returns the obtained bid value as the screen data GD₃₃₁ of the order entry guidance screen to the buyer terminal 10-m. In a second processing, when receiving the order entry information OD from the buyer terminal 10-m, the control unit 310 adds the received order entry information OD to the order management database ODB-k. In a third processing, when receiving the message MS₂₂₀ from the supplier terminal 20-n, the control unit 310 obtains the most recent bid value from each piece of bid information RD in the bid management database RDB-k while obtaining the total number of the most recent orders from each order entry information OD in the order management database ODB-k at the time of reception of the message MS₂₂₀, and returns the obtained total number of the orders and the bid value as the screen data GD₃₃₂ of the bid guidance screen to the supplier terminal 20-n. In a fourth processing, when receiving the bid information RD from the supplier terminal 20-n and determining to accept the reception of the new bid by the bid information RD, the control unit 310 adds the bid information RD to the bid management database RDB-k. Thus, according to the first embodiment, the buyer can determine that a unit price of the item P-k is lowered to his or her own planned amount for purchase, and then perform the application which has been jointly ordered. Therefore, according to the first embodiment, the number of orders from buyers who want to have the target item P-k to be auctioned but will not purchase the target item P-k of the auction even if paying a higher amount than an amount convenient for themselves are driven up. In addition, according to the first embodiment, there can be such expected effects that an increase in the number of buyers drives up a bid to a lower desired successful bid unit price than that from the supplier, and the bid at the lower desired successful bid unit price drives up orders from a greater number of buyers. Therefore, according to the first embodiment, it is possible to make a scale merit due to group orders larger.

In addition, in the first embodiment, only when the bid information RD received from the supplier terminal 20-n satisfies the condition a2 or b2, the control unit 310 allows the new bid by the bid information RD, and adds a record including the bid information RD to the bid management database RDB-k. Thus, it is possible to prevent waste of the resource of the storage unit 340 which occurs because the bid information RD of a supplier who is hardly likely to be a successful bidder is stored in the bid management database RDB-k.

In addition, in the first embodiment, the control unit 310 determines that the bid information RD received from the supplier terminal 20-n satisfies the condition a2 or b2, adds a record including the bid information RD in the bid management database RDB-k, and then transmits a message indicating that the new bid has been made to the supplier terminal 20-n of the transmission source of the bid information RD whose bidding order has been the first so far. Thus, the control unit 310 can encourage a re-bid at a lower desired successful bid unit price by notifying a supplier who thinks that he or she can become a successful bidder even without changing an order acceptance condition of the fact that he or she cannot become the successful bidder in a state of the order acceptance condition.

As described above, the first embodiment has been described, but a modification which will be described below can be added to the first embodiment.

### Second Embodiment

In the first embodiment, after the auction result output processing PRC2 with respect to some item P-k (item P−1 in the above-described first embodiment), the control unit 310 may select the bid information RD whose bidding order is not the first from the bid information RD within each record in the bid management database RDB-k of the item P-k, and transmit information to solicit the purchase of the item P-k at the desired successful bid unit price indicated by the bid information RD to the buyer terminal 10-k of each buyer. More specifically, in the second embodiment, the control unit 310 selects bid information RD_{2ND} with a prescribed ranking (for example, the second) of the second or below from the bid information RD within each record in the bid management database RDB-k at the end time t_{END} of the auction period T-k for the item P-k. Next, the control unit 310 creates screen data of an additional recruitment guidance screen in which the bid information RD_{2ND} is embedded in a model described by HTML. In addition, the control unit 310 transmits, to an e-mail address of the buyer terminal 10-m (m=1 to M), an e-mail in which a URL of the screen data and character strings “Recruit additional group purchaser of ◯◯. If you want to purchase, please log into additional recruitment guidance screen” are embedded. According to the second embodiment, it is possible to give a sales opportunity for the item P-k to a supplier who is impaired because the supplier has become a successful bidder in the group purchasing reverse auction.

### Third Embodiment

In the above-described first embodiment, on an order guidance screen of the item P-k which allows each buyer to browse the screen, a reduction rate obtained by dividing the most recent bid value by a unit price before discount of the item P-k may be displayed. In addition, on the order guidance screen of the item P-k, the number of bids for the item P-k may be displayed.

### Fourth Embodiment

In the first embodiment, the buyer and the supplier may be allowed to browse an auction history for the item P-k on which group purchasing reverse auction has already been held. More specifically, in the third embodiment, on a main screen of a reverse auction site, a button labeled as “result of auction held in the past is here” is disposed. When the buyer or the supplier performs an operation of selecting this button, the control unit 310 creates image data of a history screen on which histories of the reception of the order entry information OD and the bid information RD in the target item P-k of the past group purchasing reverse auction are written in chronological order, and transmits the image data to the buyer terminal 10-m or the supplier terminal 20-n.

In addition, an auction history for the item P-k on which the group purchasing reverse auction is currently held rather than the auction history of the past may be browsed. For example, as an embodiment in which the buyer can browse the auction history for the group purchasing reverse auction currently held, a history browsing button is disposed on the order entry guidance screen, and a message requesting browsing of the auction history is transmitted to the buyer terminal 10-m at a timing of performing an operation of selecting the history browsing button. Meanwhile, in the control unit 310, the following processing is executed. That is, history information in which the order entry information OD and bid information RD for the target item P-k are arranged in chronological order (in order from early reception time) is created at a timing of reception of the message, and the image data in which the history information is displayed in the form of a list is returned to a transmission source of the message. According to the present embodiment, from a progress of the total number of orders and price movement of the unit price, buyers who try to purchase the target item P-k can be allowed to predict to some extent how much further the unit price is withdrawn by their orders.

In addition, as an embodiment in which the supplier can browse the auction history for the group purchasing reverse auction currently held, a history browsing button is disposed on the bid guidance screen, and a message requesting browsing of the auction history is transmitted to the supplier terminal 20-n at a timing of performing an operation of selecting the history browsing button. Meanwhile, in the control unit 310, the following processing is executed. That is, history information in which the order entry information OD and bid information RD for the target item P-k are arranged in chronological order is created at a timing of reception of the message, and the image data in which the history information is displayed in the form of the list is returned to a transmission source of the message. According to the embodiment, from the progress of the total number of orders and the price movement of the unit price, it is possible for suppliers who try to successfully bid for the sales of the target item P-k not only to understand the progress of the total number of orders (that is, demand) for the target item P-k but to understand bid tendencies of bidding suppliers, and therefore it is possible to determine whether a successful bid is possible if the unit price is lowered to a certain extent or whether a new bid is possible by predicting the total number of orders which can be predicted at the unit price.

### Fifth Embodiment

In the above-described first embodiment, it is not necessary that the item P-k which is a target of the group purchasing reverse auction should be a product. Services provided in exchange for the payment may be the item P-k which is the target of the group purchasing reverse auction.

### Sixth Embodiment

In the above-described first embodiment, each supplier who participates in the group purchasing reverse auction for the item P-k has the sufficient stock of the item P-k, and a providable quantity designated as the order acceptance condition by each supplier at each time point of the auction period T-k is larger than a sum of the number of orders designated as an order condition by each buyer for the auction period T-k. Therefore, in the first embodiment, regardless of the total number of orders designated as the order condition by each buyer for the auction period T-k, all of the buyers who become the group orderer can purchase the item P-k from the supplier who becomes a bidder. However, in a case in which the supplier who becomes the bidder does not have the sufficient stock of the item P-k, a case may occur in which, when the total number of orders at the end time t_{END} of the auction period T-k exceeds the providable quantity of the supplier, some of the buyers cannot purchase the item P-k from the supplier. As a technical means to avoid confusion of the transaction when the above-described case occurs, the first or the second embodiment as shown below may be adopted.

In the first embodiment, the control unit 310 extracts the bid information RD indicating a providable quantity larger than the total number of orders at the end time t_{END} of the auction period T-k for the item P-k from the bid information RD within each record in the bid management database RDB-k at the end time t_{END} of the auction period T-k for the item P-k, selects bid information RD indicating the lowest desired successful unit price from the extracted bid information RD, and determines the selected bid information RD as the bid information RD_{1ST} whose bid is the first in order.

More specifically, in the embodiment, when the auction period T-k of the item P-k is completed, the control unit 310 reads out the order entry information OD within each record in the order management database ODB-k at the end time t_{END} of the auction period T-k to the volatile storage unit 344. The control unit 310 uses a sum of the number of orders indicated by each order entry information OD in the volatile storage unit 344 as the total number of orders of the item P-k at the end time t_{END}. Next, the control unit 310 extracts the bid information RD indicating a providable quantity larger than the above-described total number of orders from the bid information RD within each record in the bid management database RDB-k at the end time t_{END}, and reads the extracted bid information RD out to the volatile storage unit 344. In addition, the control unit 310 ranks each piece of bid information RD in the volatile storage unit 344 in the same sequence as in step S322 described above, and determines the bid information RD ranked first as the bid information RD_{1ST}. In the present embodiment, a successful bidder is selected from suppliers who make a bid for the providable quantity larger than the total number of orders at the end time t_{END} of the auction period T-k. Thus, the total number of orders at the end time t_{END} of the auction period T-k exceeds the providable quantity of the supplier who becomes the successful bidder, and therefore a case may not occur in which some of the buyers cannot purchase the item P-k from the supplier.

In the second embodiment, the control unit 310 reads out each order entry information OD within each record in the order management database ODB-k one by one to the reverse auction support device 30 in order from early transmission time of the order entry information OD, determines whether the total number of orders indicated by the order entry information OD which has been read so far whenever reading out the order entry information OD one by one reaches the providable quantity indicated by the bid information RD_{1ST} whose bid is the first in order, and outputs a message indicating that an order cannot be received with respect to the order entry information OD which has not been read yet when the total number of orders reaches the providable quantity indicated by the bid information RD_{1ST} whose bid is the first in order.

More specifically, in the embodiment, when the auction period T-k for the item P-k is completed, the control unit 310 searches the bid information RD (that is, bid information with the lowest desired successful bid unit price) which is finally added to the bid management database RDB−1 among each piece of bid information RD of the bid management database RDB−1, determines the searched bid information RD as the bid information RD_{1ST} whose bid is the first in order, and obtains a providable quantity NumR_{1ST} indicated by the bid information RD_{1ST}. Next, the control unit 310 reads out the order entry information OD_{1ST}, which is initially stored in the order management database ODB-k to the volatile storage unit 344, and compares a number of orders NumO_{1ST} indicated by the order entry information OD_{1ST} with the providable quantity NumR_{1ST}. Next, in the case of NumO_{1ST}≦NumR_{1ST}, the control unit 310 reads out the order entry information OD_{2ND} which is stored second in the order management database ODB-k to the volatile storage unit 344, obtains a number of orders NumO_{2ND} indicated by the order entry information OD_{2ND}, and compares a sum Σ of the number of orders NumO_{1ST} and the number of orders NumO_{2ND} with the providable quantity NumR_{1ST}.

The control unit 310 repeats the above-described processing while increasing the number of times of reading out the order entry information OD until the sum Σ of the number of orders reaches the providable quantity NumR_{1ST}. Next, when the sum Σ of the number of orders reaches the providable quantity NumR_{1ST} at the time of reading out some order entry information OD, the control unit 310 transmits the above-described message MS₄₁₀ (e-mail message including directions representing a procedure of the conclusion of the contract for the sale and purchase) to the buyer terminal 10-m of a transmission source of the order entry information OD which has been read so far from the order management database ODB-k, and transmits a message MS₄₁₀ indicating that the order for the item P-k cannot be accepted by the buyer terminal 10-m of a transmission source of the order entry information OD which has not been read yet from the order management database ODB-k.

In the embodiment, when the total number of orders at the end time t_{END} of the auction period T-k exceeds the providable quantity of the supplier who become the successful bidder, purchasing rights of the item P-k is allocated to the buyers in order from early transmission of the order entry information OD. Therefore, it is possible to give an incentive to encourage early orders for each buyer.

In this manner, by giving the incentive to encourage the early orders to each buyer, the following effects can be expected. In general, in business transactions, there is a tendency that as a company of a purchaser of a product is larger, a transaction quantity per one-time transaction is increased and a unit price is lowered. Thus, in the first embodiment, when a large company and small and medium sized companies are included among the buyers who try to purchase the item P-k, it can be considered that the large company is highly likely to suspend an order until a unit price is sufficiently withdrawn, and orders from the small and medium sized companies occupy the majority of the orders immediately after the start of the group purchasing reverse auction. Thus, the price change in the unit price in the first embodiment can be considered as follows. That is, since the orders from the small and medium sized companies immediately after the start of the group purchasing reverse auction occupy the majority of the orders, it can be considered that the total number of orders is gradually increased, and the unit price is gradually reduced. When the large company begins to participate in the order, it can be considered that the total number of orders is rapidly increased, and the unit price is also rapidly reduced to the extent desired by the large company. When an incentive to encourage early orders is given to each buyer in a situation where such price movement is assumed, submission of applications for orders by the small and medium sized companies immediately after the start of the group purchasing reverse auction is stimulated, and therefore it is expected to promote stimulation of the overall market. This is because, in a situation where the unit price of the product indicates the above-described price movement, the small and medium sized companies place orders early, and therefore can reliably ensure a desired number of products while benefiting from large orders (that is, can purchase product with unit price at a transaction level of the large company) by the large company which will come to participate in the order later.

### Seventh Embodiment

In the auction result output processing PRC2 of the above-described first embodiment, when one or more pieces of bid information RD are stored in the bid management database RDB−1 at the end time t_{END} of the auction period T−1 for the item P−1 and one or more pieces of order entry information OD are stored in the order management database ODB−1, a transaction for the item P−1 has been unconditionally established. However, when the total number of orders at the end time t_{END} of the auction period T-k is significantly small, the transaction for the item P−1 may not be established. Specifically, as a condition for establishing the transaction, when a threshold value with respect to the total number of orders is determined in advance, when one or more pieces of bid information RD are stored in the bid management database RDB−1 at the end time t_{END} of the auction period T−1 for the item P−1, and when the total number of orders at the end time t_{END} of the auction period T-k exceeds the threshold value, the transaction can be established. The threshold value may be determined by each operation manager of the reverse auction support device 30 for each item, or determined always at a constant value irrespective of the item. In addition, a minimum transaction quantity for enabling a transaction to be established when bid information is transmitted may be designated by each supplier, and therefore the designated minimum transaction quantity of the supplier whose bid is the first in order may be used as the threshold value. Here, as a method for designating the minimum transaction quantity, an embodiment in which the minimum transaction quantity is independently designated separately from the providable quantity may be used, and an embodiment in which the minimum transaction quantity is designated by a percentage (for example, 80% or the like of providable quantity) of the providable quantity may be used. In general, this is because each supplier lowers the unit price because he or she can expect a certain amount of collective transactions so that a large disadvantage is given to the suppler whose bid is the first in order when the transaction is established even in a case in which the total number of orders is significantly small, and therefore there is a risk of reluctance to participate in the next and subsequent auctions.

### REFERENCE SIGNS LIST

10 BUYER TERMINAL
20 SUPPLIER TERMINAL
30 REVERSE AUCTION SUPPORT DEVICE
310 CONTROL UNIT
320 COMMUNICATION I/F UNIT
330 U/I UNIT
340 STORAGE UNIT
342 NONVOLATILE STORAGE UNIT
344 VOLATILE STORAGE UNIT
350 BUS

1. A reverse auction support system comprising:
a buyer terminal used by each buyer of a target item that is a target of a reverse auction;
a supplier terminal used by each supplier of the target item; and
a reverse auction support device,
wherein the reverse auction support device includes:
a communication interface that communicates with the supplier terminal through a communication network while communicating with the buyer terminal through the communication network,
a first database that associates a buyer identifier of each buyer with order entry information including the number of orders of the target item designated as an order condition by each buyer for storing the associated information,
a second database that associates a supplier identifier of each supplier with bid information including a desired successful bid unit price for the target item designated as an order acceptance condition by each supplier for storing the associated information, and
control means that executes,
for a predetermined auction period for the target item,
first processing for receiving a message requesting browsing of the most recent bid value of the target item from the buyer terminal through the communication interface, determining a minimum amount of the desired successful bid unit price indicated by the bid information in the second database as the most recent bid value at the time of reception of the message, and returning the bid value to the buyer terminal through the communication interface,
second processing for receiving the order entry information from the buyer terminal through the communication interface, and updating stored contents of the first database by adding a pair of the buyer identifier of the buyer of a transmission source of the received order entry information and the order entry information to the first database,
third processing for receiving a message requesting browsing of the total number of the most recent orders and the most recent bid value from the supplier terminal through the communication interface, determining the minimum amount of the desired successful bid unit price indicated by each piece of the bid information in the second database as the most recent bid value at the time of reception of the message while determining a sum of the number of orders indicated by each order entry information in the first database as the total number of the most recent orders at the time of reception of the message, and returning the total number of the orders and the bid value to the supplier terminal through the communication interface, and
fourth processing for receiving the bid information from the supplier terminal through the communication interface, and updating stored contents of the second database by adding a pair of the supplier identifier of the supplier of a transmission source of the received bid information and the bid information to the second database, and
after the auction period is completed,
fifth processing for selecting the bid information whose bid is the first in order from each piece of the bid information in the second database at the time of completion of the auction period, and outputting a set of the selected bid information and all of the order entry information in the first database as an auction result of the reverse auction for the target item.

2. The reverse auction system according to claim 1, wherein
the bid information includes the desired successful bid unit price designated as the order condition by the supplier and a providable quantity, and
in the fourth processing, the control means determines the bid information received from the supplier terminal as a determination target of a new bid, selects the bid information whose bid is the first in order from each piece of bid information in the second database at the time of reception of the bid information determined as the determination target, and adds a pair of the supplier identifier of the supplier of a transmission source of the bid information determined as the determination target and the bid information to the second database when the bid information determined as the determination target includes the desired successful bid unit price lower than the bid information whose bid is the first in order or when the bid information determined as the determination target includes the desired successful bid unit price with the same amount as the bid information whose bid is the first in order and the providable quantity larger than the bid information.

3. The reverse auction system according to claim 2, wherein, in the fourth processing, the control means transmits, when adding new bid information to the second database, a message indicating that a new bid has been made to the supplier terminal of the transmission source of the bid information whose bidding order has been the first so far.

4. The reverse auction system according to claim 1, wherein the control means determines whether the total number of orders indicated by the order entry information exceeds a predetermined threshold value at the time of completion of the auction period, and executes the fifth processing when the total number of orders exceeds the predetermined threshold value.

5. The reverse auction support system according to claim 4, wherein
the bid information includes a minimum transaction quantity, and
the control means uses the minimum transaction quantity included in the bid information whose bid is the first in order, as the threshold value.

6. The reverse auction system according to claim 2, wherein, in the fifth processing, the control means selects the order entry information in a range in which the total number of orders falls within the providable quantity in order from early transmission time of the order entry information when the total number of orders exceeds the providable quantity of the bid information whose bid is the first in order, and outputs a set of the selected order entry information and the bid information whose bid is the first in order as the auction result.

7. The reverse auction system according to claim 1, wherein, when receiving a message requesting browsing of a history of orders and bids for the past reverse auction which has held or the reverse auction currently held from the supplier terminal or the buyer terminal, the reverse auction support device executes sixth processing for reading the corresponding bid information from the second database while reading the corresponding order entry information from the first database, creating auction history information by arranging the order entry information and the bid information in chronological order, and returning the created auction history information to a transmission source of the message requesting the browsing of the history.

8. A reverse auction support device comprising:
a communication interface that communicates with each supplier terminal of a target item that is a target of a reverse auction through a communication network while communicating with each buyer terminal of the target item through the communication network;
a first database that associates a buyer identifier of each buyer with order entry information indicating an order condition of the target item designated by each buyer for storing the associated information;
a second database that associates a supplier identifier of each supplier with bid information indicating an order acceptance condition of the target item designated by each supplier for storing the associated information; and
control means that executes,
for a predetermined auction period for the target item,
first processing for receiving a message requesting browsing of the most recent bid value of the target item from the buyer terminal through the communication interface, determining a minimum amount of a desired successful bid unit price indicated by the bid information in the second database as the most recent bid value at the time of reception of the message, and returning the bid value to the buyer terminal through the communication interface,
second processing for receiving the order entry information from the buyer terminal through the communication interface, and updating stored contents of the first database by adding a pair of the buyer identifier of the buyer of a transmission source of the received order entry information and the order entry information to the first database,
third processing for receiving a message requesting browsing of the total number of the most recent orders and the most recent bid value from the supplier terminal through the communication interface, determining the minimum amount of the desired successful bid unit price indicated by each piece of the bid information in the second database as the most recent bid value at the time of reception of the message while determining a sum of the number of orders indicated by each order entry information in the first database as the total number of the most recent orders at the time of reception of the message, and returning the total number of the orders and the bid value to the supplier terminal through the communication interface, and
fourth processing for receiving the bid information from the supplier terminal through the communication interface, and updating stored contents of the second database by adding a pair of the supplier identifier of the supplier of a transmission source of the received bid information and the bid information to the second database, and
after the auction period is completed,
fifth processing for selecting the bid information whose bid is the first in order from each piece of bid information in the second database at the time of completion of the auction period, and outputting a set of the selected bid information and all of the order entry information in the first database as an auction result of the reverse auction for the target item.

9. The reverse auction support device according to claim 8, wherein the bid information includes the desired successful bid unit price designated as the order condition by the supplier and a providable quantity, and
in the fourth processing, the control means determines the bid information received from the supplier terminal as a determination target of a new bid, selects the bid information whose bid is the first in order from each piece of bid information in the second database at the time of reception of the bid information determined as the determination target, and adds a pair of the supplier identifier of the supplier of the transmission source of the bid information determined as the determination target and the bid information to the second database when the bid information determined as the determination target includes the desired successful bid unit price lower than the bid information whose bid is the first in order or when the bid information determined as the determination target includes the desired successful bid unit price with the same amount as the bid information whose bid is the first in order and the providable quantity larger than the bid information.

10. The reverse auction support device according to claim 9, wherein, in the fourth processing, the control means transmits, when adding new bid information to the second database, a message indicating that a new bid has been made to the supplier terminal of the transmission source of the bid information whose bidding order has been the first so far.

11. The reverse auction support device according to claim 8, wherein the control means determines whether the total number of orders indicated by the order entry information exceeds a predetermined threshold value at the time of completion of the auction period, and executes the fifth processing when the total number of orders exceeds the predetermined threshold value.

12. The reverse auction support device according to claim 11, wherein
the bid information includes a minimum transaction quantity, and
the control means uses the minimum transaction quantity included in the bid information whose bid is the first in order, as the threshold value.

13. The reverse auction support device according to claim 9, wherein, in the fifth processing, the control means selects the order entry information in a range in which the total number of orders falls within the providable quantity in order from early transmission time of the order entry information when the total number of orders exceeds the providable quantity of the bid information whose bid is the first in order, and outputs a set of the selected order entry information and the bid information whose bid is the first in order as the auction result.

14. The reverse auction support device according to claim 8, wherein, when receiving a message requesting browsing of a history of orders and bids for the past reverse auction which has held or the reverse auction currently held from the supplier terminal or the buyer terminal, the control means executes sixth processing for reading out the corresponding bid information from the second database while reading out the corresponding order entry information from the first database, creating auction history information by arranging the order entry information and the bid information in chronological order, and returning the created auction history information to a transmission source of the message requesting the browsing of the history.

15. A program for causing a computer to realize
a first database that associates a buyer identifier of each buyer of a target item that is a target of a reverse auction with order entry information indicating an order condition of the target item designated by each buyer for storing the associated information,
a second database that associates a supplier identifier of each supplier of the target item with bid information indicating an order acceptance condition of the target item designated by each supplier for storing the associated information, and
control means that executes,
for a predetermined auction period for the target item,
first processing for receiving a message requesting browsing of the most recent bid value of the target item from the buyer terminal through the communication interface, determining a minimum amount of a desired successful bid unit price indicated by the bid information in the second database as the most recent bid value at the time of reception of the message, and returning the bid value to the buyer terminal through the communication interface,
second processing for receiving the order entry information from the buyer terminal through the communication interface, and updating stored contents of the first database by adding a pair of the buyer identifier of the buyer of a transmission source of the received order entry information and the order entry information to the first database,
third processing for receiving a message requesting browsing of the total number of the most recent orders and the most recent bid value from the supplier terminal through the communication interface, determining the minimum amount of the desired successful bid unit price indicated by each piece of the bid information in the second database as the most recent bid value at the time of reception of the message while determining a sum of the number of orders indicated by each order entry information in the first database as the total number of the most recent orders at the time of reception of the message, and returning the total number of the orders and the bid value to the supplier terminal through the communication interface,
fourth processing for receiving the bid information from the supplier terminal through the communication interface, and updating stored contents of the second database by adding a pair of the supplier identifier of the supplier of a transmission source of the received bid information and the bid information to the second database, and
after the auction period is completed,
fifth processing for selecting the bid information whose bid is the first in order from each piece of the bid information in the second database at the time of completion of the auction period, and outputting a set of the selected bid information and all of the order entry information in the first database as an auction result of the reverse auction for the target item.

16. The program according to claim 15, wherein
the bid information includes the desired successful bid unit price designated as the order condition by the supplier and a providable quantity, and
in the fourth processing, the control means determines the bid information received from the supplier terminal as a determination target of a new bid, selects the bid information whose bid is the first in order from each piece of bid information in the second database at the time of reception of the bid information determined as the determination target, and adds a pair of the supplier identifier of the supplier of a transmission source of the bid information determined as the determination target and the bid information to the second database when the bid information determined as the determination target includes the desired successful bid unit price lower than the bid information whose bid is the first in order or when the bid information determined as the determination target includes the desired successful bid unit price with the same amount as the bid information whose bid is the first in order and the providable quantity larger than the bid information.

17. The program according to claim 16, wherein, in the fourth processing, the control means transmits, when adding new bid information to the second database, a message indicating that a new bid has been made to the supplier terminal of the transmission source of the bid information whose bidding order has been the first so far.

18. The program according to claim 15, wherein the control means determines whether the total number of orders indicated by the order entry information exceeds a predetermined threshold value at the time of completion of the auction period, and executes the fifth processing when the total number of orders exceeds the predetermined threshold value.

19. The program according to claim 18, wherein
the bid information includes a minimum transaction quantity, and
the control means uses the minimum transaction quantity included in the bid information whose bid is the first in order, as the threshold value.

20. The program according to claim 16, wherein, in the fifth processing, the control means selects the order entry information in a range in which the total number of orders falls within the providable quantity in order from early transmission time of the order entry information when the total number of orders exceeds the providable quantity of the bid information whose bid is the first in order, and outputs a set of the selected order entry information and the bid information whose bid is the first in order as the auction result.

21. The program according to claim 15, wherein, when receiving a message requesting browsing of a history of orders and bids for the past reverse auction which has held or the reverse auction currently held from the supplier terminal or the buyer terminal, the control means executes sixth processing for reading out the corresponding bid information from the second database while reading out the corresponding order entry information from the first database, creating auction history information by arranging the order entry information and the bid information in chronological order, and returning the created auction history information to a transmission source of the message requesting the browsing of the history.
